(19) United States
(12) Patent Application Publication
(10) Pub. No.: US 2007/0222426 A1
(43) Pub. Date: Sep. 27, 2007

(54) Wireless Powering Device, an Energiable Load, a Wireless System and a Method For a Wireless Energy Transfer

(75) Inventors: Eberhard Waffenschmidt, Aachen (DE); Harald Reiter, Aachen (DE); Carsten Deppe, Aachen (DE); Georg Sauerlander, Aachen (DE); Bernd Ackermann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,473

(22) PCT Filed: Apr. 28, 2005
(86) PCT No.: PCT/IB05/51394

§ 371 Date: Oct. 30, 2006

(30) Foreign Application Priority Data
May 4, 2004 (EP) 04101901.9

(51) Int. Cl. H01F 38/14

(52) U.S. Cl. 323/355

(57) ABSTRACT

A wireless resonant powering device 1 according to the invention comprises a first inductor winding 3, which is arranged to form a transformer 9 with the inductor winding 13 of the energizable load 11. The first inductor winding 3 is arranged to form a resonant circuit 5, which may comprise a suitable plurality of electric capacitances and coils. The components of the resonant circuit 5 are selected such that the magnetic energy received by the inductor winding 13 damps the energy flow in the resonant circuit so that the induced voltage in the inductor winding 13 is substantially constant and is independent of the magnetic coupling between the first inductor winding 3 and the inductor winding 13 at the operating frequency of the driving means 6. The resonant circuit is driven by the driving means 6, comprising a control unit 6c arranged to induce an alternating voltage between a first semiconductor switch 6a and a second semiconductor switch 6b. At the output of the transformer 9 an alternating voltage is generated, which is rectified to a DC-voltage by a diode rectifier, filtered by an output capacitance. The resonant circuit 5 is operable on its coupling independent point by the driving means 6. This figure schematically illustrates a situation, where a variable coupling between the first inductor winding 3 and the inductor winding 13 exists. The invention further relates to a wireless inductive powering device, an energizable load, a wireless system and a method for wireless power transfer.

The invention relates to a wireless resonant powering device for a wireless energy transfer to an energizable load comprising an inductor winding, said device comprising a resonant circuit.

The invention further relates to a wireless inductive powering device for a wireless energy transfer to an energizable load comprising an inductor winding, said wireless inductive powering device comprising a transformer with
a softmagnetic core;
a first inductor winding accommodated in the softmagnetic core and being conceived to interact with the inductor winding when the indictor winding is positioned in a vicinity of said core for purposes of forming the transformer.
   The invention still further relates to an energizable load.
   The invention still further relates to a wireless system.

The invention still further relates to a method of a wireless energy transfer from a wireless resonant powering device to an energizable load comprising an inductor winding, said method comprising the steps of:
providing a wireless resonant powering device arranged with a first inductor winding, whereby said first inductor forms a part of a resonant circuit conceived to generate a magnetic flux in a volume.

The invention still further relates to a method for wireless energy transfer from a wireless inductive powering device to an energizable load comprising an inductor winding, said method comprising the step of:
providing a wireless inductive powering device arranged with a first inductor winding, whereby said inductor winding and said first inductor winding are conceived to form a transformer.

An embodiment of a wireless resonant powering device as is set forth in the opening paragraph is known from U.S. 2004/0000974. The known device comprises a first coiled conductor and a second coiled conductor separated by an energy transfer interface, whereby said conductors comprise a resonant configuration operable at a resonant frequency. The energy transfer between the conductors in the known device is enabled by a capacitive coupling therebetween due to the energy transfer interface being a non-conductive dielectric material.

It is a disadvantage of the known device that in case when a coupling between the first conductor and the second conductor varies, the known device requires a feed-back signal for controlling an output voltage at a power receiving conductor.

It is an object of the invention to provide a wireless resonant powering device for wireless power transfer whereby it provides a substantially constant transferred energy without a need for any feed-back signal, even for situations with a variable coupling between the first inductor winding and the inductor winding.

To this end in the wireless resonant powering device according to the invention said resonant circuit comprises a first inductor winding conceived to generate a magnetic flux in a volume, whereby, in operation, the inductor winding is conceived to be positioned to intercept at least a portion of said flux in said volume, said resonant powering device further comprising:
a driving means connectable to the resonant circuit and arranged to operate substantially on a pre-selected operational frequency, such that, in operation, an induced voltage in the inductor winding is independent of the magnetic coupling between the first inductor winding and the inductor winding.

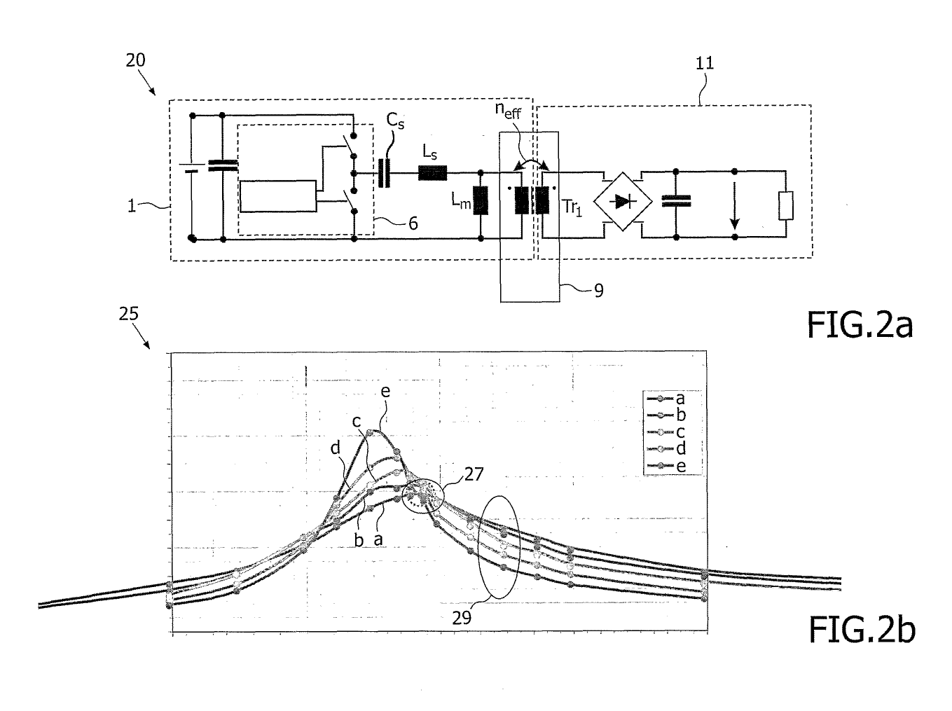

The technical measure of the invention is based on the insight that the components of the resonant circuit can be selected such that the magnetic energy received by the inductor winding damps the energy flow in the resonant circuit such that the induced voltage in the inductor winding is substantially constant and is independent of the magnetic coupling between the first inductor winding and the inductor winding at the operational frequency of the driving means. It is essential that the operating frequency is not equal to the resonant frequency of the resonant circuit. Preferably, the resonant circuit is arranged as a series connection between a suitable capacitance and the first inductor winding. Alternatively, the resonant circuit may comprise a suitable number of additional capacitive and/or inductive elements. The technical background of this insight will be discussed in more detail with reference to FIGS. 2a and 2b. According to the technical measure of the invention the device operates at the coupling independent point, whereby the energy transfer is substantially constant, independent of the quality of the coupling between the inductor winding and the first inductor winding. Therefore no feed-back signal is required.

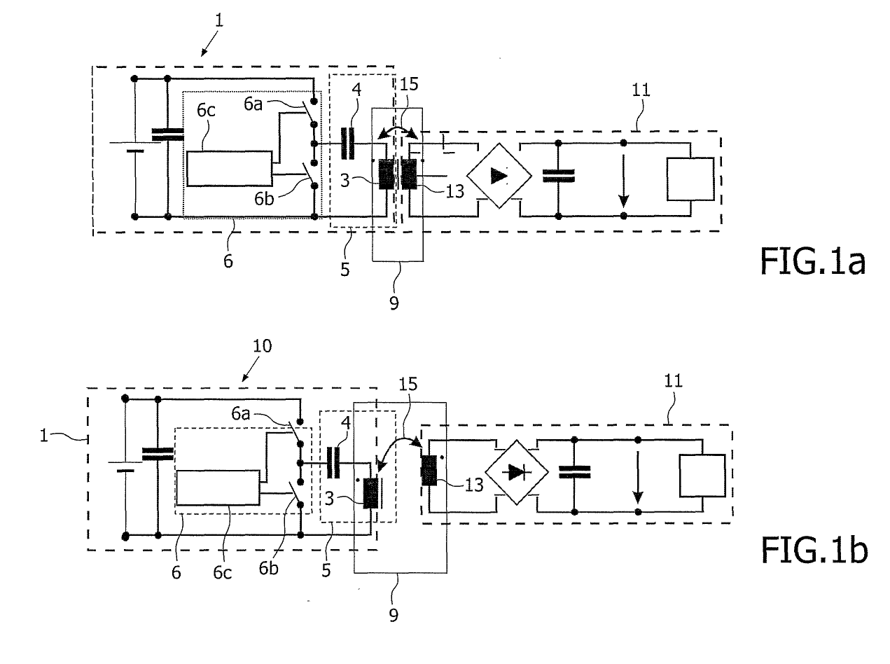

In an embodiment of the wireless resonant powering device according to the invention the driving means comprises a half bridge topology. Preferably, the half bridge topology comprises two semiconductor switches and a control unit arranged to induce an alternating voltage between the two semiconductor switches. The advantages of this embodiment will be discussed in more detail with reference to FIGS. 1a and 1b.

It must be noted, that according to the technical measure of the invention it is possible to implement a plurality of wireless resonant powering devices applicable in a variety of technical fields. For example, application areas could vary from a charging device, like a charging pad whereon a rechargeable load can be positioned for purposes of receiving a charging current. Additionally, the wireless powering device according to the invention is suitable for enabling an energy transfer between moving parts, like in an automotive, railway wagon, or in any other industrial application requiring a wireless powering of a suitable load cooperating with the wireless resonant powering device. Still additionally, the wireless powering device according to the invention is applicable for enabling an energy transfer between wearable components of, for example, a body monitoring system.

In a still further embodiment of the wireless resonant powering device according to the invention it further comprises a data storage unit arranged for transmitting and/or for receiving data upon an event a communication between the first inductor winding and the inductor winding is established. This embodiment is found to be particularly advantages in situations, where a substantial amount of data is to be uploaded or downloaded from or to the energizable load. This uploading or downloading is preferably carried out during recharging of a rechargeable battery of the energizable load, for time and energy saving purposes.

In a wireless inductive powering device according to the invention the softmagnetic core comprises mutually displaceable a first portion of the core and a second portion of the core to alternate between a closed magnetic circuit and an open magnetic circuit.

The technical measure of the invention is based on the insight that by providing a softmagnetic core which can be opened and closed, on one hand an improved magnetic coupling is achieved and, on the other hand an external magnetic field is reduced. It must be understood that for implementation of the softmagnetic core any suitable material characterized by a magnetic permeability larger than 1 is applicable. Preferred embodiments of the suitable implementations of the softmagnetic core comprise sintered ferrite cores, cores made of laminated iron or iron alloy sheets, iron powder cores, ferrite polymer compound cores, cores made from amorphous or nano-crystalline iron or iron alloys.

The invention is applicable to any suitable wireless inductive powering device, for example for implementing respective charging units, for example for mobile, handheld, and wearable devices. The wireless inductive powering device according to the invention is in particular advantageous for a charging solution for body-worn monitoring systems, a diagnostic and alarm forwarding systems for continuous medical monitoring for patients. According to the technical measure of the invention an easily and comfortably usable, efficient and low radiating wireless energy transfer to, for example a sealed, flexible and washable load is enabled. Accordingly, the wireless inductive powering device comprises the transformer with the core, which can be flapped open. This construction of the core is particularly suitable for operating with a load which comprises a suitable inductor winding arranged as a thin planar winding contained in a suitable sealed energy receiving unit. It can easily be put in the opened transformer core. After closing the core, a good transformer is obtained allowing a well coupled, efficient power transmission with low emitted fields.

Thus, due to the technical measure of the invention contactless charging of mobile handheld devices like mobile phones, PDAs and wearable monitoring systems improves exploitation comfort thereof. Especially in the technical field of personal monitoring the solution according to the invention is advantageous.

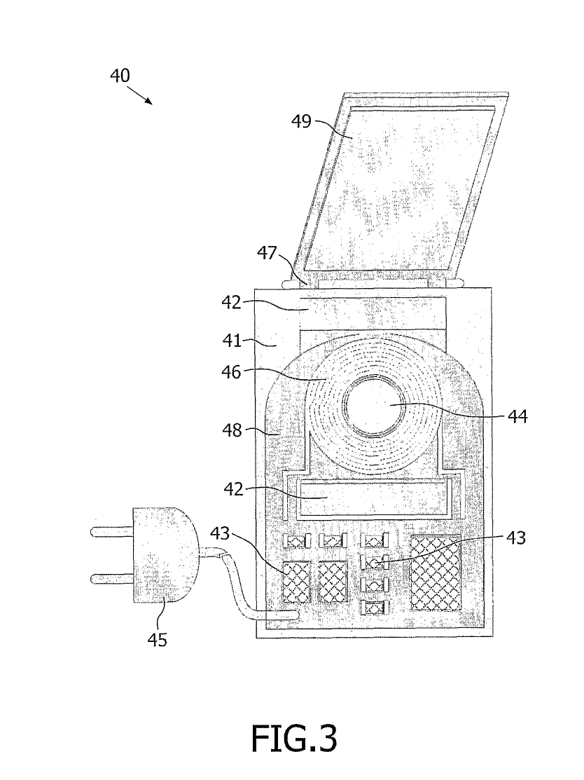

Following possibilities for enabling powering of an energizable load are known per se in the art. First, a plug connection is known and is widely applicable. A plug connection has the disadvantage that the contacts may oxidize, if the device comes in contact to water. Furthermore, the plugs are a source for a water leakage. At last, it is uncomfortable to connect a flexible device to a cable connection. Therefore, a plug connection is not favoured and a contactless power transfer is preferred. Secondly, existing solutions with a good coupling like for example in an electrical toothbrush require a three dimensional, bulky arrangement of windings. However, such a solution is not feasible for a thin, flexible device. A further solution comprises a wireless charging pad, as is for example known from SpashPad™. Such a system consists of a charging pad generating a magnetic field and a receiver in the mobile device, in which a current is induced by the magnetic field to supply the mobile device or to charge a battery. However, such a system has two disadvantages: first, the efficiency of such a system is not optimal. As a further disadvantage, the system inherently produces external magnetic fields, which might be dangerous, especially for application in a medical environment. As is demonstrated above, all these disadvantages of the prior art are solved by the wireless inductive powering device according to the invention. The advantages of the wireless inductive powering device according to the invention are illustrated with reference to FIG. 3.

In a preferred embodiment, the first inductor winding is arranged in a form of spiral tracks of a printed circuit board. Advantageously, the printed circuit board can be used for accommodating necessary electronic means. A variety of suitable electronic means can be used, for example per se known load resonant converters or standard topologies, like flyback converter, forward converter, asymmetric halvebridge converter and standard resonant halvebridge converter are suitable.

In an embodiment of the wireless inductive powering device the softmagnetic core comprises an air gap between the first portion of the core and the second portion of the core. Fly back converters require a certain inductivity of the first inductor winding. This is achieved by provision of the air gap between the first portion and the second portion of the softmagnetic core.

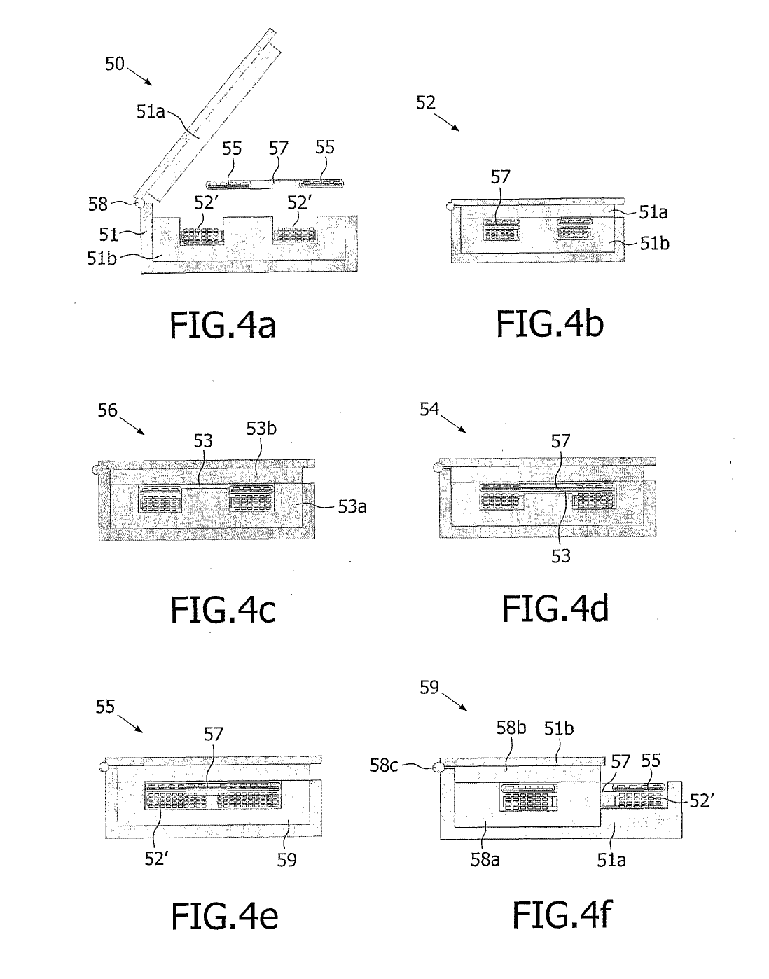

In principle, a plurality of geometric arrangements of the softmagnetic core is suitable for practicing the invention. For instance, the softmagnetic core may be arranged in an E-type configuration, which is schematically shown in FIGS. 4a-4e. FIG. 4e shows an E-shaped core with an omitted central leg, in this case E- refers to a path of the magnetic flux. Omitting the central leg has an advantage that it is possible to increase a number of turns in the inductor winding and first inductor winding, which is particularly advantageous in case the inductor winding is supported by a very thin device. In another example a suitable softmagnetic core is arranged in a U-shape, which is schematically illustrated in FIG. 4f.

Additionally, ring-shaped cores are possible. If the ring core has a suitable air gap it may act as a transformer and a hook at the same time. This is especially advantageous in combination with a wearable energizable load like e.g. a jacket. The hanger of the wearable energizable load contains the inductor winding in a way that the inductor winding surrounds the magnetic core and is thus well magnetically coupled to the first inductor winding, when the wearable energizable load is hanged on the hook with the hanger. The hook-shaped transformer can be part of a wardrobe.

In a still further embodiment of the wireless inductive powering device according to the invention the wireless inductive powering device comprises a housing for accommodating the first portion of the core, the first inductor winding being arranged on the first portion, the first portion being fixed to the housing.

This particular arrangement enables an easy operation of the wireless inductive powering device, whereby the second portion of the core is preferably arranged on a flap of a softmagnetic material and is conceived to be displaced. Also, the second portion of the core may be constructed as a flap. Preferably, the housing is further arranged to support necessary electronics and suitable cabling for connecting to an external power supply means.

In a still further embodiment of the wireless powering system according to the invention the first portion of the core and/or the housing are dimensioned to form an alignment means for positioning of the inductor winding.

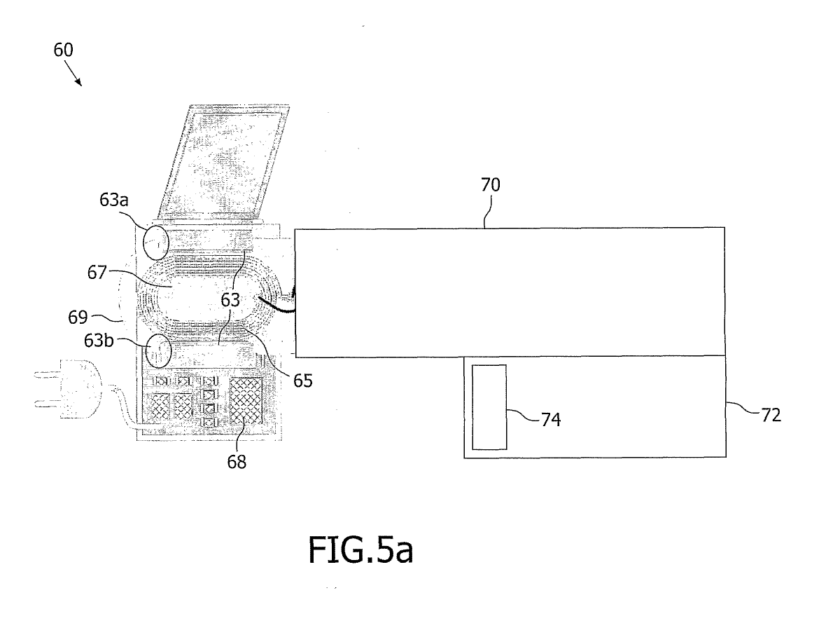

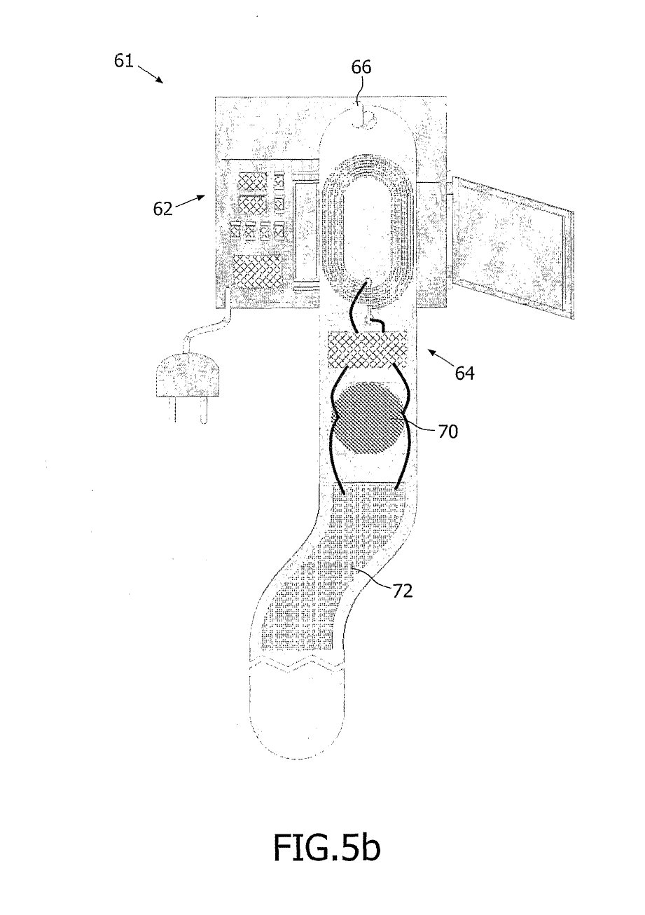

This technical measure results in an increased efficiency of the wireless inductive powering device by ensuring a good alignment between the inductor winding and the first inductor winding. Preferably the alignment means is arranged to cooperate with respective means of the load. A preferred example is shown in FIG. 5a, where the load is provided with two recesses at the outside, which fit to the outer legs of the core.

Any of the embodiments presented so far may also be used in a vertical arrangement. This way the powering device can be used as a comfortable means for storage of the load just by hanging it on a wall like a tie, while simultaneously recharging the battery. In this case the energizable load can be a piece of cloth, like a jacket. Such a powering device may be arranged in the wardrobe. It can be imagined to have several of these stations beside each other to store a number of loads, e.g. in a central storage room in a hospital. One embodiment shown in FIG. 5b is especially advantageous for this application. It has a hook on the top of the powering device, on which the load can be hung. Since it is hanging down vertically, the hook determines well the position of the load, such that no recess or other means to fix a load position is mandatory.

In a still further embodiment the wireless inductive powering device according to the invention comprises a primary circuit for electrically connecting the first inductor winding to a power supply source, said primary circuit comprising an electric security means for preventing electric damaging of the first inductor winding.

If the softmagnetic core is opened, the magnetic circuit is opened and the inductivity of the first inductor winding is reduced. When the primary circuit is in operation then, a higher current may flow in the first inductor winding. To prevent an electric damage of the primary circuit in this case, few measures are possible. The first measure is to dimension the primary circuit such that it can withstand the high current. Alternatively, an over current protection circuit can be used. Preferably, a current sensor is arranged to measure the current in the first inductor winding. It is connected to a further circuit, which controls the current, preferably to the maximum load current. Such further circuit inherently reacts on an inductivity reduction and automatically reduces the applied voltage. Suitable implementations for the further electronics are known per se in the art. Further improvement is realised with a foldback current limit, like it is used in known per se voltage regulator devices, where the current limit is proportional to the voltage. In this way after opening the core the current drops to nearly zero. Depending on dimensioning, a standby operation without any further need to switch on or off can be realised. The third measure is a contact or a switch, which is operated, when the core is opened. In a most simple arrangement, the switch opens the primary circuit, such that current can only flow in the first inductor winding, only when the core is closed.

In a still further embodiment of the wireless inductive powering device the first inductor winding is further arranged to form a part of a resonant circuit conceived to generate a magnetic flux in a volume, the primary circuit further comprising a driving means connectable to the resonant circuit, arranged to operate substantially on a pre-selected operational frequency, such that, in operation, an induced voltage in the inductor winding is independent of the magnetic coupling between the first inductor winding and the inductor winding, when the inductor winding is positioned to at least partially intercept said magnetic flux.

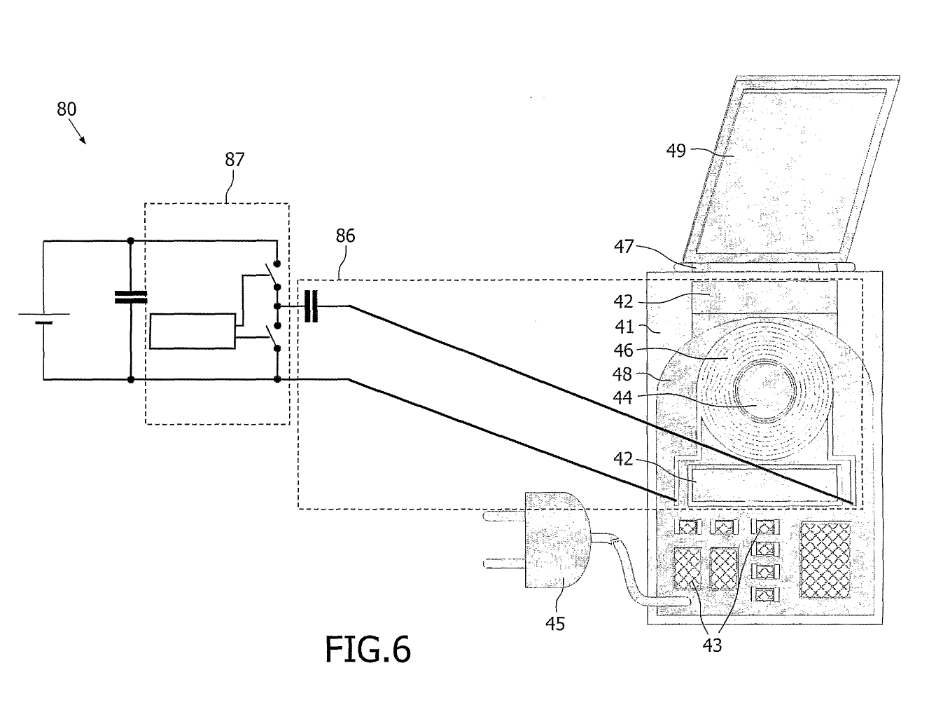

According to this technical measure, the value of the output voltage at the first inductor winding remains sufficiently constant even when the magnetic coupling between the inductor winding and the first inductor winding varies. The resonant circuit is preferable formed by a series capacitance connected to the first inductor winding. The concept of the coupling independent point is explained with reference to FIGS. 2a and 2b. Preferably, the driving means comprises a half bridge topology. Still preferably the half bridge topology comprises two semiconductor switches and a control unit arranged to induce an alternating voltage between the two semiconductor switches. The operation of this embodiment of the wireless inductive powering device is illustrated with reference to FIG. 6.

In a still further embodiment of the wireless inductive powering device according to the invention the first portion of the core and the second portion of the core are connectable by a lever arranged to close automatically when a portion of the energizable load is positioned there between. This has an advantage that the core automatically closes when the load is positioned between its first portion and its second portion.

In a still further embodiment of the wireless inductive powering device it comprising a data storage means arranged to transmit and/or to receive data from the inductor winding upon an event a communication between the first inductor winding and the inductor winding is established.

Preferably, the data transmission is carried out during a recharging of a battery of the energizable load. Various suitable modes of implementations of a wireless transfer are known per se in the art. In case the energizable load is an entertainment unit, the data may comprise music, movie or any other suitable information, including alpha-numerical information, or an executable computer code. This data is then stored in the further data storage unit and is accessible for the user. For medical application, the downloadable data may comprise doctor's recommendations, diagnosis, appointments, medication scheme, dieting recommendations, or the like. When the data is transferred from the load to the wireless powering device, the data preferably comprises the status of the charging process. Additionally, any suitable upload from the load to the wireless inductive powering device can take place, comprising, for example data collected during the operation of the load, or any other suitable information about the user and the load. Those skilled in the art will appreciate that various embodiments of the data are possible without departing the scope of the invention.

The energizable load according to the invention comprises the inductor winding for cooperating with the first inductor winding of the wireless resonant powering device or the wireless inductive powering device according to the invention.

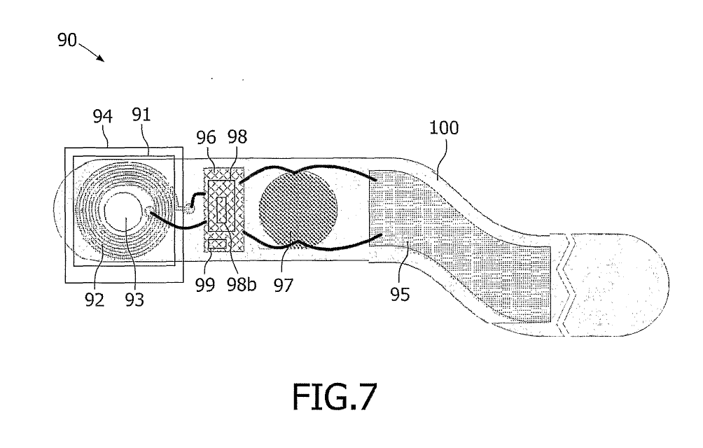

Advantageous embodiments of the energizable load according to the invention are set forth with reference to claims 19-26. In a further advantageous embodiment the energizable load comprises monitoring means. Preferably, the energizable load is wearable. A plurality of wearable devices is possible, including, but not limited to a radio, a walkman, a MP3-player, a watch, an electronic game, a remote control, a PDA, position or altitude indicator, communication means, like a mobile telephone, etc. Still preferably the energizable load is arranged as a flexible wearable support member, comprising suitable sensor electronics for purposes of a vital sign monitoring. A preferred embodiment of the energizable load is illustrated with reference to FIG. 7. This technical measure is based on the insight that especially in the field of personal health care or personal monitoring customers or patients whose vital sign is being monitored have to cope with a provided monitoring system on their own. Hence, handling and usage of the system is very important to the reliability of the data. Therefore, the electronics is miniaturized and preferably sealed, whereby the monitoring electronics is preferably integrated into wearables. Battery replacement by the users is not possible due to sealing and is frequently not accepted, especially by elderly people who are subjected to a continuous monitoring of, for example, a heart activity. Therefore, there is a need for a wireless and easy to apply rechargeable solutions.

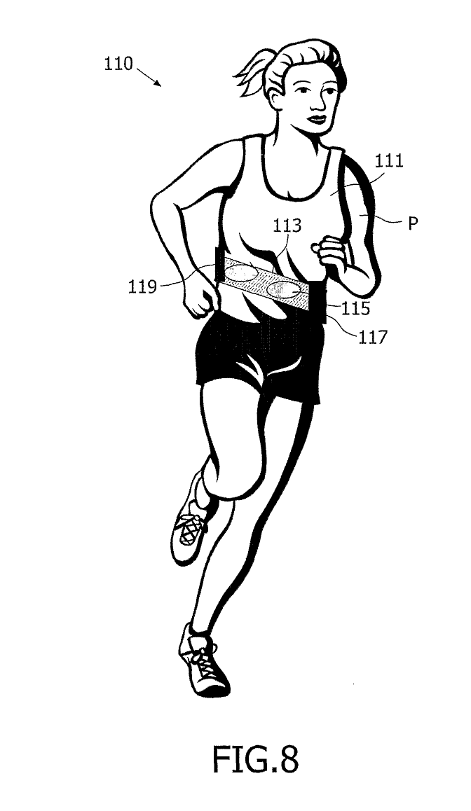

The wearable monitoring system according to the invention provides comfortable means for recharging a battery of the monitoring device. As an advantage, any external electric wiring of the wearable monitoring system is abandoned, still further improving a wearing comfort and a durability of the monitoring system as a whole. It must be noted that although a specific example of a monitoring event is named, this should be interpreted as a mere illustration and not as a limiting feature. The person skilled in the art will acknowledge that a plurality of possible body-worn monitoring systems can be implemented for different purposes, without departing the scope of the invention. An example of a suitable wearable monitoring system is shown in FIG. 8.

The wireless system according to the invention is set forth in claim 32. The wireless system according to the invention is applicable in a variety of technical fields. For example, application areas could vary from a charging device, like a charging pad whereon a rechargeable load can be positioned for purposes of receiving a charging current. Additionally, the wireless system according to the invention is suitable for enabling an energy transfer between moving parts, like an automotive, railway wagon, or in any other industrial application requiring a wireless powering of a suitable load cooperating with the wireless resonant powering device. Still additionally, the wireless system according to the invention is applicable for enabling an energy transfer between wearable components of, for example, a body monitoring system.

A first embodiment of the method according to the invention comprises the steps of:
positioning the inductor winding so that it intercepts at least a portion of the magnetic flux;
connecting a driving means to the resonant circuit, whereby the driving means is arranged to operate on a pre-selected operational frequency, such that, in operation, an induced voltage in the inductor winding is independent of the magnetic coupling between the first inductor winding and the inductor winding,
operating the resonant circuit on the operational frequency to wirelessly transfer energy from the first inductor winding to the inductor winding.

A second embodiment of the method according to the invention comprises the steps of:
arranging the first inductor winding in a vicinity of a part of a softmagnetic core for purposes of forming the transformer, wherein said core comprises mutually displaceable a first portion of the core and a second portion of the core alternating between a closed magnetic circuit and an open magnetic circuit;
positioning the inductor winding between the first portion of the core and the second portion of the core for a wireless power transfer to the energizable load.

Further advantageous embodiments of the method according to the invention are set forth in claims 35-38.

These and other aspects of the invention are discussed in further details with reference to figures, wherein like reference signs refer to like items.

FIG. 1a presents in a schematic way an embodiment of an electric circuit of the wireless resonant powering device according to the invention for a good coupling between the first inductor winding and the inductor winding.

FIG. 1b presents in a schematic way an embodiment of an electric circuit of the wireless resonant powering device according to the invention for a decreased coupling between the first inductor winding and the inductor winding.

FIG. 2a presents in a schematic way an equivalent electric circuit of the wireless resonant powering device according to the invention.

FIG. 2b present in a schematic way a voltage transfer ratio for varying coupling conditions.

FIG. 3 presents in a schematic way an embodiment of the wireless inductive powering device according to the invention.

FIG. 4a shows in a schematic way a side view of an embodiment of an E-shaped softmagnetic core according to the invention.

FIG. 4b shows in a schematic way a side view of an embodiment of an E-shaped softmagnetic core in a closed state.

FIG. 4c shows in a schematic way a side view of an embodiment of an E-shaped softmagnetic core in a closed state with an air gap between the first portion of the core and the second portion of the core.

FIG. 4d shows in a schematic way a side view of a further embodiment of an E-shaped softmagnetic core in a closed state with an air gap between the first portion of the core and the second portion of the core.

FIG. 4e shows in a schematic way a side view of a further embodiment of an E-shaped softmagnetic core in a closed state.

FIG. 4f shows in a schematic way a side view of an embodiment of a U-shaped softmagnetic core in a closed state.

FIG. 5a shows in a schematic way an embodiment of a wireless inductive powering device, where alignment means is provided.

FIG. 5b shows in a schematic way an embodiment of a wireless inductive powering device arranged to enable a power transfer to a vertically oriented load.

FIG. 6 shows in a schematic way an embodiment of the wireless inductive powering device comprising a resonant means.

FIG. 7 presents in a schematic way an embodiment of the energizable load according to the invention.

FIG. 8 presents in a schematic view an embodiment of a wearable monitoring system according to the invention.

FIG. 1a presents in a schematic way an embodiment of an electric circuit of the wireless resonant powering device according to the invention for a good coupling between the first inductor winding and the inductor winding. The wireless resonant powering device 1 according to the invention comprises the first inductor winding 3, which is arranged to form a transformer 9 with the inductor winding 13 of the energizable load 11. The first inductor winding 3 and a series capacitance 4 are arranged to form a resonant circuit 5. The resonant circuit 5 may comprises a suitable plurality of electric capacitances and coils. The driving means 6 is arranged to operate the resonant circuit at the coupling independent point, the concept of which is explained with reference to FIGS. 2a and 2b. The driving means 6 comprises a control unit 6c arranged to induce an alternating voltage between a first semiconductor switch 6a and a second semiconductor switch 6b. Preferably, the semiconductor switches are realized by a Field Effect Transistor. At the output of the transformer 9 an alternating voltage is generated, which is rectified to a DC-voltage by a diode rectifier, filtered by an output capacitance. FIG. 1a schematically illustrates a situation, where a good coupling between the first inductor winding 3 and the inductor winding 13 exists. FIG. 1b presents in a schematic way an embodiment of an electric circuit of the wireless resonant powering device according to the invention for a decreased coupling between the first inductor winding and the second inductor winding, other items being the same. This decreased coupling is caused by the fact that the inductor winding 13 is located not sufficiently close to the first inductor winding 3.

FIG. 2a presents in a schematic way an equivalent electric circuit of the wireless resonant powering device according to the invention. The two windings of the transformer 9 can be represented by a leakage inductivity Ls, the main inductivity Lm and an ideal transformer Tr1 with an effective voltage transfer ration neff. The sum of Ls and Lm always equals the inductivity of the first inductor winding L, thus Ls+Lm=L. The weaker the coupling, the larger the leakage inductivity Ls. The ratio Ls/L is defined as the leakage factor. The weaker the coupling, the higher is the leakage factor Ls/L. Capacitance Cs and inductivity L represent a series resonant circuit, which output voltage is a fraction of the resonant voltage across the inductor L. A series resonant circuit 5 is used, that means, that a capacitor (or a parallel connection of more capacitors) is connected in series to the first inductor winding. This technical measure is applied to adapt the characteristic impedance of this resonance circuit. The characteristic impedance Zo is equal to the impedance of the inductor winding L11 or the impedance of the capacitor C at the resonance frequency (expressed by the angular frequency ωₚ). Both are the same at the resonance frequency. Alternatively, the characteristic impedance Z₀ is equal to the square root of the ratio of the inductor to the capacitor:

$${Z}_{0} = \frac{1}{{ω}_{p} C} = {ω}_{p} {L}_{11} = \sqrt{\frac{{L}_{11}}{C}}$$

This characteristic impedance Zo must be in a certain relation to the equivalent load resistance, also called primary side related load resistance. This is the resistance of the load R_{L}, divided by the square of the turns ratio n_{phys}, which is the ratio of the number of secondary turns to the number of primary turns. Preferably, the characteristic impedance should be approximately two times the equivalent resistance to achieve a coupling independent behavior. But also at a ratio in the range from 1 to 10 an operation according to the invention can be possible. If the ratio is too low, the resonance is too much damped, and the coupling gets a too large influence. If the ratio is too high, the resonant circuit is too less damped and must be operated close to the resonant frequency, where the output voltage strongly varies, if the load changes. The precise dimensioning for a certain operating frequency is determined by the following equation:

$$\frac{{Z}_{0}}{{R}_{L}} {n}_{phys}^{2} = \frac{1 - \frac{1}{{Ω}^{2}}}{\sqrt{\frac{1 - {σ}_{1}}{{σ}_{1} - {σ}_{2}} ( \frac{1}{Ω} - {σ}_{2} Ω ) - \frac{1 - {σ}_{2}}{{σ}_{1} - {σ}_{2}} {( \frac{1}{Ω} - {σ}_{1} Ω )}^{2}}}$$

where σ₁ and σ₂ are two different leakage factors and Ω is the operating frequency related to the resonant frequency of the resonant circuit. The equation gives the value needed for the characteristic impedance in relation to a certain load resistance. Knowing the characteristic impedance, the ratio of the inductivity and capacity is determined (see above). The equation results from the request that at two different coupling situations the transferred voltage must be equal. Thus based on this fundamental insight a suitable resonant circuit can be designed which enables a constant energy transfer to a suitable energizable load, which is independent of the magnetic coupling between the first inductor winding and the inductor winding.

FIG. 2b present in a schematic way a measured voltage transfer ratio as a function of operating frequency for varying coupling conditions Ls/L. The figure shows five typical curves for different leakage factors Ls/L, ranging from 0.27 (curve a) to 0.6 (curve e). All curves show a resonant peak with a high voltage transfer ratio at a resonant frequency of about 65 kHz.

It is understood, that a known typical application will use the frequency range above the resonance, because in this range the input impedance of the resonant circuit is inductive, which may allow low loss Zero Voltage Switching of the halve bridge switches. For frequencies far above the resonance the circuit behaves similar to a conventional circuit, because the impedance of the capacitor is low, such that it can be considered as a short circuit. As can be seen in FIG. 2b, the output voltage decays, if the coupling becomes worse. This is shown in the area 29 of FIG. 2b. The output voltage varies more than 50% over the entire rage of typical leakage factors. For a good coupling the output voltage may be thus two times higher than for a weak coupling, which is disadvantageous. At the resonance frequency, the dependence of the output voltage on the leakage factor is reversed. As FIG. 2b shows, actually a weaker coupling leads to a higher output voltage. This happens, because due to the weaker coupling the series resonant circuit is less damped.

Therefore, somewhere close to the resonant frequency there is an optimal operating frequency, where the two effects compensate and the voltage transfer curves of the various couplings cross each other. The resonant frequency is about 65 kHz for a circuit of FIG. 1a, where R_{L} is 56 Ohm, Uout=5V, L=13 mH, Cs=440 pF N2/N1=13/230. The point where curves a-d cross each other is marked as area 27 and is referred to as Coupling Independent Point. It is seen, that different curves a-d do not exactly match in a single point. However, one can find a frequency, where a variation of the coupling leads to a minimized variation of the output voltage. With this technical measure the output voltage remains within about a 10% margin for the whole relevant range of the leakage factor, which means that there is no need for a feed-back signal for controlling the output voltage.

FIG. 3 presents in a schematic way an embodiment of the wireless inductive powering device according to the invention. The wireless inductive powering device 40 comprises a softmagnetic core 42,44,49 which can be flapped open. For this purpose the first portion of the core 42,44 is connected to the second portion of the core 49 by means of a suitable hinge 47. Alternatively, the second portion 49 may be slide away using a suitable guiding means (not shown). Preferably, the first portion 42, 44 is fixed to a suitable housing 41, which also supports necessary electronics 43, connected to an external power supply source (not shown) by a cable 45. The wireless inductive powering device 40 comprises the first inductor winding 46 arranged in a vicinity of the core, preferably around its middle leg 44, thus forming a primary winding of the transformer. Preferably, the first inductor winding 46 is integrated on a printed circuit board 48. The first inductor winding generates a magnetic flux through the closed core, when the second portion 49 is positioned above the first portion 42,44. Various arrangements of the softmagnetic core are possible. Some preferred embodiments thereof are schematically illustrated in FIGS. 4a-4f.

FIG. 4a shows in a schematic way a side view of an embodiment of an E-shaped softmagnetic core 50 according to the invention. The first portion 51b of the softmagnetic core is E-shaped, whereby the first inductor winding 52 is wound around its central leg. The second portion of the core 51a is rotatably arranged around a hinge 58. When a suitable energizable load 57 is positioned between the first portion of the core 51b and the second portion of the core 51a, as is shown in FIG. 4b, a reliable transformer is obtained allowing a well coupled, efficient power transmission.

FIG. 4c shows in a schematic way a side view of an embodiment of an E-shaped softmagnetic core in a closed state with an air gap between the first portion of the core 53a and the second portion of the core 53b. It is understood, than some circuitry, like a Flyback converter require certain inductivity of the first inductor winding. This is achieved by introducing an air gap 53 between the first portion 53a and the second portion 53b of the softmagnetic core 56.

FIG. 4d shows in a schematic way a side view of a further embodiment of an E-shaped softmagnetic core 54 in a closed state with an air gap between the first portion and the second portion of the core. In this embodiment the dimension of the air gap 53 is increased, so that the energizable load does not have to be provided with an opening cooperating with the central leg of the E-shaped core.

FIG. 4e shows in a schematic way a side view of a further embodiment of an E-shaped softmagnetic core 55 in a closed state, whereby a central leg is omitted. In this case E-shape refers to the path of the resulting the magnetic flux. Thus shaped first portion of the core 53c is advantageous as it allows adding more turns in the inductor winding 55 and the first inductor winding 52′, which is in particular advantageous for a very thin energizable load 57.

FIG. 4f shows in a schematic way a side view of an embodiment of a U-shaped softmagnetic core 59 in a closed state. The U-shaped first portion of the core 58a is arranged within the housing 51a, so that there is space to accommodate the first inductor winding 52′ therebetween. The U-shaped first portion of the core 58a has a cooperating flap 58b, which may be supported by a housing 51b. The displacement of the second portion of the core 51b is enabled by a hinge 58c. This embodiment of the softmagnetic core is also suitable to cooperate with a load 57, provided with a suitable inductor winding 55.

FIG. 5a shows in a schematic way an embodiment of a wireless inductive powering device 60, where alignment means are provided. Although a plurality of suitable alignment means are thinkable, the preferred embodiment comprises a particularly shaped core or housing 62, having suitable recesses 63 to accommodate cooperating surfaces 63a, 63b of the energizable load 69. Any suitable configuration of the recesses 63 and surfaces 63a, 63b is possible. Additionally, the wireless inductive powering device 60 may comprise a data storage unit 68 arranged to transmit and/or to receive data from the further data storage unit 74 of the energizable load 69. Preferably, the data transmission is carried out during a recharging of a battery 70. Various suitable modes of implementations of a wireless transfer are known per se in the art. In case the load 69 is an entertainment unit, the data may comprise music, movie or any other suitable information, including alpha-numerical information, or an executable computer code. This data is then stored in the further data storage unit 74 and is accessible for the user. For medical application, the downloadable data may comprise doctor's recommendations, diagnosis, appointments, medication scheme, dieting recommendations, or the like. When the data is transferred from the load 69 to the wireless powering device 60, the data preferably comprises the status of the charging process. Additionally, any suitable upload from the load 69 to the wireless inductive powering device 60 can take place, comprising, for example data collected during the operation of the load 69, or any other suitable information about the user and the load 69.

FIG. 5b shows in a schematic way an embodiment of a wireless inductive powering device arranged to enable a power transfer for a vertically oriented load. Hereby, the energizable load 64 is powered from the wireless inductive powering device 62. In this case, the wireless inductive device comprises a support means 66, whereon the load 64 can be arranged. Preferably, the support means comprise a hook, however other embodiments are possible, including Velcro band. For example, in this vertical position, the energizable load may be arranged to charge a battery 70, feeding a suitable electronics 72. A preferable embodiment of the electronics is a monitoring system, in particular a monitoring system integrated into a body wear. This embodiment is illustrated with reference to FIG. 8.

FIG. 6 shows in a schematic way an embodiment of the wireless inductive powering device comprising a driving means. The driving means 87, implemented, for example in accordance with FIG. 2a, is arranged to drive the resonant circuit 86 formed by the first inductor winding 46 and the capacitance 84. The driving means 86 is electrically connected to the electronics 43 of the wireless inductive powering device, as is described with reference to FIG. 3. The functioning of the driving means is in accordance with FIGS. 1a and 1b.

FIG. 7 presents in a schematic way an embodiment of the energizable load according to the invention. As is indicated earlier, a plurality of suitable energizable loads is possible. This particular embodiment shows a monitoring system 90, integrated on a piece of a wearable 100, for example on an elastic belt. The monitoring system 90 comprises the inductor winding 92, which is preferably manufactured on a flexible printed circuit board 91. It must be noted that the inductor winding 92 may stretch further than is strictly required to surround the leg of the transformer. This feature has an advantage, that the inductor winding gains a higher tolerance to placing errors, still improving the reliability of the wireless power transfer. Still preferably, the board 91 is sealed in a water-impermeable unit 94 so that the whole monitoring system can be washable. This feature is particularly advantageous for monitoring systems arranged for continuous monitoring, for example of a health-related parameter. In case the monitoring system 90 is arranged to cooperate with an E-shaped softmagnetic core of a suitable wireless powering station, an opening 93 in the material of the wearable 100 is provided. When in the inductor winding 92 a current is induced, it can be, for example, used to charge a rechargeable battery 97 in the receiver circuit. To adapt the induced current to the battery 97, an electronic circuit 96 is used. This electronic circuit comprises in the simplest case a rectifier to convert the induced ac current in to a dc charging current. In a more sophisticated solution, this circuit comprises of a charge control circuit 98, which controls the charging current, the charging time and which is able to manage load schemes dedicated to the battery type. It may also have indicators 99 for the status of the charging process. The wireless inductive powering device 60 may also have indicators of the charging status (not shown). The monitoring system 90 induces only a small external radiation of magnetic fields, because the magnetic circuit is well closed. The radiation is comparable to a standard wired charger, which also contains a transformer.

FIG. 8 presents in a schematic view an embodiment of a wearable monitoring system according to the invention. The wearable monitoring system 110 according to the invention is arranged as a body-wear 111 for an individual P. The monitoring system 110 comprises a flexible carrier 113 arranged for supporting suitable sensing means 115. preferably, for improving a wearing comfort, the carrier 113 is implemented as an elastic belt, whereto, for example, a number of electrodes (not shown) is attached. It must be noted that although in the current embodiment a T-shirt is depicted, any other suitable wearables are possible, including, but not limited to an underwear, a brassier, a sock, a glove, a hat. The sensing means 115 is arranged to measure a signal representative of a physiological condition of the individual P. Preferably, the inductor winding is woven or stitched into the fabric of a suitable wearable in a form of a spiral. This solution is most comfortable and flexible. The purpose of such monitoring may be a medical one, for example, a monitoring of a temperature, a heart condition, a respiration rate, or any other suitable parameter. Alternatively, the purpose of monitoring may be fitness- or sport-related, whereby an activity of the individual P is being monitored. For this purpose the sensing means 115 is brought into contact with the individual's skin. Due to the elasticity of the carrier 113, the sensing means experience a contact pressure which keeps it substantially in place during a movement of the individual P. The measured signal is forwarded from the sensing means 115 to the control unit 117 for purposes of signal analysis or other data processing. The control unit 117 may be coupled to a suitable alarming means (not shown). The monitoring system 115 according to the invention further comprises a conductor loop 119, which is arranged to be energizable using wireless energy transfer. This energy may be received from a wireless resonant powering device, as is shown in FIG. 1a. Alternatively, or additionally, the energy may be received from the wireless inductive powering device, as is shown with reference to FIG. 3. In the latter case, the inductor winding 119 must be positioned between the first portion and the second portion of the softmagnetic core of the wireless inductive powering device.

Although the invention has been described with reference to preferred embodiments thereof, it is to be understood that these are not limitative examples. Thus, various modifications may become apparent to those skilled in the art, without departing from the scope of the invention, as is defined by the claims. The invention may be implemented by means of both hardware and software, and that several “means’ may be presented by the same item in hardware.

1. A wireless resonant powering device (1) for a wireless energy transfer to an energizable load (11) comprising an inductor winding (13), said device comprising:
a resonant circuit (5), wherein said resonant circuit comprises a first inductor winding (3) conceived to generate a magnetic flux in a volume, whereby, in operation, the inductor winding is conceived to be positioned to intercept at least a portion of said flux in said volume, said resonant powering device (1) further comprising:
a driving means (6) connectable to the resonant circuit (5) and arranged to operate substantially on a pre-selected operational frequency, such that, in operation, an induced voltage in the inductor winding is independent of the magnetic coupling between the first inductor winding (3) and the inductor winding (13).

2. A wireless resonant powering device according to claim 1, wherein the driving means (5) comprises a half bridge topology (6).

3. A wireless resonant powering device according to claim 2, wherein the half bridge topology (6) comprises two semiconductor switches (6a, 6b) and a control unit (6c) arranged to induce an alternating voltage between the two semiconductor switches.

4. A wireless resonant powering device according to claim 1, further comprising a data storage unit (68) arranged for transmitting and/or for receiving data upon an event a communication between the first inductor winding and the inductor winding is established.

5. A wireless inductive powering device (40) for a wireless energy transfer to an energizable load (57) comprising an inductor winding (52), said wireless inductive powering device comprising a transformer with
a softmagnetic core (42,44,49);
a first inductor winding (46) accommodated in the softmagnetic core and being conceived to interact with the inductor winding, when the inductor winding is positioned in a vicinity of said core for purposes of forming the transformer, wherein the softmagnetic core comprises mutually displaceable a first portion of the core (42,44) and a second portion of the core (49) to alternate between a closed magnetic circuit and an open magnetic circuit.

6. A wireless inductive powering device (40) according to claim 5, wherein the first inductor winding (46) comprises a loop of a conductor arranged on a printed circuit board (48).

7. A wireless inductive powering device (56) according to claim 5, wherein the softmagnetic core comprises an air gap (53) between the first portion of the core (53a) and the second portion of the core (53b).

8. A wireless inductive powering device (50) according to claim 5, wherein the wireless powering device comprises housing (51) for accommodating the first portion of the core (51b), the first inductor winding (52) being arranged on the first portion of the core (51b), the first portion of the core being fixed to the housing (51).

9. A wireless inductive powering device (60) according to claim 8, wherein the first portion of the core (51b) and/or the housing (51) are dimensioned to form an alignment means (63) for positioning of the inductor winding (65).

10. A wireless inductive powering device (60) according to claim 9, being arranged for charging the load when the load is positioned substantially vertically, the housing being further dimensioned to form a support means (66) for the inductor winding (65).

11. A wireless inductive powering device according to claim 5, further comprising a primary circuit (43) for electrically connecting the first inductor winding to a power supply source, said primary circuit comprising an electric security means for preventing electric damaging of the first inductor winding.

12. A wireless inductive powering device according to claim 11, wherein the electric security means comprises a current sensor arranged for controlling a magnitude of the current in the first inductor winding.

13. A wireless inductive powering device according to claim 11, wherein the electric security means comprises an electric switch arranged to open the primary circuit upon yielding the open magnetic circuit.

14. A wireless inductive powering device (80) according to claim 5, wherein the first inductor winding is further arranged to form a part of a resonant circuit (86) conceived to generate a magnetic flux in a volume, the primary circuit further comprising a driving means (87) connectable to the resonant circuit (86), arranged to operate substantially on a pre-selected operational frequency, such that, in operation, an induced voltage in the inductor winding is independent of the magnetic coupling between the first inductor winding and the inductor winding, when the inductor winding is positioned to at least partially intercept said magnetic flux.

15. A wireless inductive powering device according to claim 14, wherein the driving means comprises a half bridge topology.

16. A wireless inductive powering device according to claim 15, wherein the half bridge topology comprises two semiconductor switches and a control unit arranged to induce an alternating voltage between the two semiconductor switches.

17. A wireless inductive powering device according to claim 5, wherein the first portion of the core (51a) and the second portion of the core (51b) are connectable by a lever arranged to close automatically when a portion of the energizable load is positioned therebetween.

18. A wireless inductive powering device according to claim 5, further comprising a data storage means arranged to transmit and/or to receive data from the inductor winding upon an event a communication between the first inductor winding and the inductor winding is established.

19. An energizable load (90) comprising an inductor winding (92) for cooperating with the first inductor winding of the wireless resonant powering device according to claim 1.

20. An energizable load (90) according to claim 19, wherein the inductor winding (92) comprises a loop of a conductor arranged on a flexible printed circuit board (91).

21. An energizable load (90) according to claim 20, wherein the inductor winding (92) is connectable to a rechargeable battery (97) by means of charging electronics (96).

22. An energizable load (90) according to claim 21, wherein the charging electronics comprises a charge control unit (98) for controlling a total charge delivered to the battery by the inductor winding.

23. An energizable load (90) according to claim 22, wherein the charge control unit (98) is further arranged to select a charging scheme (98b) from a plurality of pre-stored charging schemes in accordance with a type of the battery.

24. An energizable load (90) according to claim 23, wherein the charge control unit further comprises an indicator (99) for indicating a status of the charging process.

25. An energizable load according to claim 19, wherein the energizable load comprises further data storage means (74) arranged to enable a transmission and/or a receipt of data.

26. An energizable load according to claim 24, wherein data is transmitted, said data being indicative of a charging status.

27. An energizable load (90) according to claim 19, further comprising monitoring means (95).

28. An energizable load according to claim 27, wherein the energizable load is integrated in a substantially planar structure.

29. An energizable load according to claim 19, being waterproof.

30. An energizable load (90) according to claim 19, being integrated in a body-wear (100).

31. An energizable load according to claim 30, wherein the inductor winding comprises a wire being woven or stitched into a fabric of the body-wear (100).

32. A wireless system (60), comprising a wireless resonant powering device or a wireless inductive powering device (63) according to claim 1 and an energizable load (69) according to claim 1 and an energizable load (69) according to any one of the preceding claims 19-31.

33. A method of a wireless energy transfer from a wireless resonant powering device to an energizable load comprising an inductor winding, said method comprising the steps of:
providing a wireless resonant powering device arranged with a first inductor winding, whereby said first inductor forms a part of a resonant circuit conceived to generate a magnetic flux in a volume;
positioning the inductor winding so that it intercepts at least a portion of the magnetic flux;
connecting a driving means to the resonant circuit, whereby the driving means is arranged to operate on a pre-selected operational frequency, such that, in operation, an induced voltage in the inductor winding is independent of the magnetic coupling between the first inductor winding and the inductor winding,
operating the resonant circuit on the operational frequency to wirelessly transfer energy from the first inductor winding to the inductor winding.

34. A method of a wireless energy transfer from a wireless inductive powering device to an energizable load comprising an inductor winding, said method comprising the steps of:
providing a wireless inductive powering device arranged with a first inductor winding, whereby the inductor winding and the first inductor winding are conceived to form a transformer;
arranging the first inductor winding in a vicinity of a part of a softmagnetic core for purposes of forming the transformer, wherein said core comprises mutually displaceable a first portion of the core and a second portion of the core alternating between a closed magnetic circuit and an open magnetic circuit;
positioning the inductor winding between the first portion of the core and the second portion of the core for a wireless energy transfer to the energizable load.

35. A method according to claim 33, wherein the first inductor winding is connectable to a charge control unit, said method further comprising the steps of:
identifying a type of the energizable device;
selecting a charging program in accordance with the type using the charge control unit.

36. A method according to claim 35, wherein the method further comprises the step of:
communicating data from the wireless resonant powering device to the wireless inductive powering device and the energizable load and/or from the energizable load to the wireless powering device.

37. A method according to claim 36, wherein data is communicated from the load, said method further comprising the step of:
controlling the charging process in accordance with said data.

38. A method according to claim 34, wherein the first inductor winding forms a part of a resonant circuit conceived to generate a magnetic flux in a volume, the method further comprising the step of:
connecting a driving means to the resonant circuit, whereby the driving means is arranged to operate on a pre-selected operational frequency, such that, in operation, an induced voltage in the inductor winding is independent of the magnetic coupling between the first inductor winding and the inductor winding when the inductor winding is positioned so that it intercepts at least a portion of the magnetic flux in the volume;
operating the resonant circuit on the operational frequency to wirelessly transfer energy from the first inductor winding to the inductor winding.
